(19) United States
(12) Patent Application Publication
(10) Pub. No.: US 2022/0207315 A1
(43) Pub. Date: Jun. 30, 2022

(54) COLLECTION SUPPORT SYSTEM, COLLECTION TERMINAL DEVICE, COLLECTION SUPPORT DEVICE, AND COLLECTION SUPPORT METHOD

(71) Applicant: GS Yuasa International Ltd., Kyoto (JP)

(72) Inventors: Tomikatsu UCHIHORI, Kyoto (JP); Osamu KOBAYASHI, Kyoto (JP)

(21) Appl. No.: 17/624,766

(22) PCT Filed: Jun. 12, 2020
(86) PCT No.: PCT/JP2020/023164

§ 371 Date: Jan. 4, 2022

(30) Foreign Application Priority Data
Jul. 4, 2019 (JP) 2019-125559
Oct. 23, 2019 (JP) 2019-192901

(51) Int. Cl. G06K 19/077; G06Q 10/00

(52) U.S. Cl. CPC G06K 19/0776; G06Q 10/087; G06Q 10/30

(57) ABSTRACT

A recovery assistance system that uses a plurality of recovery terminal devices installed in a plurality of locations to assist in the recovery of an article, wherein each of the plurality of recovery terminal devices is provided with a reading unit for reading, from a tag in the form of a sticker or sheet, identification information identifying the tag. On the basis of the identification information read from a tag attached to an article, a notification about detection of the article is issued to a sales provider, manufacturer, rental provider, or transport provider of the article corresponding to the identification information.

### CROSS REFERENCE TO RELATED APPLICATIONS

This application is a national stage application, filed under 35 U.S.C. § 371, of International Application No. PCT/JP2020/023164, filed Jun. 12, 2020, which claims priority to and the benefit of Japanese Application Nos. JP2019-125559 (filed Jul. 4, 2019) and JP2019-192901 (filed Oct. 23, 2019); the contents of both of which as are hereby incorporated by reference in their entireties.

### BACKGROUND

### Technical Field

The present invention relates to a collection support system, a collection terminal device, a collection support device, and a collection support method that support the collection of articles including lost items or recyclable products.

### Description of Related Art

Various systems have been proposed in which the owner of a lost item is notified of the finding of the lost item (e.g., see Patent Document JP-A-2008-210197). However, the quantity of lost items handled by police or transportation has not decreased, and ensuring human resources for ensuring and managing storage places for lost items by police or transportation has become an issue.

In recent years, a system has been proposed that uses a tag provided with a communication means by Bluetooth (registered trademark) and a communication device such as a smartphone that communicates with the tag so that an article with the tag can be collected when the article is lost. In this system, when the communication between the communication device and the tag possessed by the owner is interrupted, it is notified that the article with the tag is separated from the owner, that is, lost, and a place where the communication is interrupted is detected by the location information acquisition function of the communication device to specify the place of the loss.

### BRIEF SUMMARY

Although various systems have been proposed, the problem of handling a lost item has not been solved sufficiently. A tag provided with Bluetooth (registered trademark) communication means itself is expensive. It is presumed that the use by end-users is not widespread because of the complexity of a registration procedure necessary for the use of the system and the need to replace the tag when battery runs out.

From the standpoint of the institution or facility where a lost item is delivered, the operation is complicated in a system that needs to operate a specific application as a business as disclosed in Patent Document JP-A-2008-210197.

An object of the present invention is to provide a collection support system, a collection terminal device, a collection support device, and a collection support method that more easily achieve collection of an article including a lost item or a recyclable product.

A collection support system uses a plurality of collection terminal devices installed at a plurality of locations to support collection of an article. Each of the plurality of collection terminal devices includes a reading unit that reads, from a tag in a form of a sticker or a sheet, identification information for identifying the tag. On a basis of the identification information read from the tag attached to an article, each of the plurality of collection terminal devices makes a notification of detection of the article to a seller, a manufacturer, a rental operator, or a carrier of the article or the tag corresponding to the identification information.

A collection terminal device includes a reading unit that reads, from a tag in a form of a sticker or a sheet, identification information for identifying the tag, and on a basis of the identification information read by the reading unit from the tag attached to an article, the collection terminal device makes a notification of detection of the article to a seller, a manufacturer, a rental operator, or a carrier of the article or the tag corresponding to the identification information.

A collection support device includes: a reception unit that receives a detection message including identification information of a sticker-like or sheet-like tag attached to an article; and a transmission unit that transmits, on a basis of the identification information of the tag included in the detection message, a detection notification of the article to a seller, a manufacturer, a rental operator, or a carrier of the article or the tag corresponding to the identification information.

A collection support method includes: reading, by at least one of collection terminal devices installed at a plurality of locations, identification information for identifying a tag in a form of a sticker or a sheet from the tag when the tag is in a reading range; and making, by the collection support device that receives a detection message from the collection terminal device, a notification of detection of the article to a seller, a manufacturer, a rental operator, or a carrier of the article or the tag corresponding to the identification information on a basis of the identification information read from the tag attached to the article.

According to the present technique, through the collection support system including the collection terminal device that reads the identification information of the tag attached to the detected article, the seller, the rental operator, or the carrier of the tag itself or the article notifies the user of the detection of the article. The collection of the article can be achieved more easily while the cost burden and procedural burden of the user and the burden of the institution or facility, to which the article is delivered, are reduced. The effect of increasing the points of contact between the user and the seller, the manufacturer, the rental operator, or the carrier of the article or the tag and improving the relationship can be expected. By applying the present technique to the collection of recyclable products, the effect of activating recycling, including reuse, can also be expected.

### BRIEF DESCRIPTION OF THE FIGURES

FIG. 1 is an outline diagram of a collection support system.

FIG. 2 is a schematic diagram illustrating one form of a tag.

FIG. 3 is a block diagram of a collection support system.

FIG. 4 illustrates an example of a screen displayed on a tag sales site.

FIG. 5 is a flowchart illustrating an example of a purchase acceptance processing procedure based on a sales screen.

FIG. 6 is a flowchart illustrating an example of a registration procedure for tag identification information in a collection support device.

FIG. 7 is a flowchart illustrating an example of the registration procedure for the tag identification information in the collection support device.

FIG. 8 is a diagram illustrating an example of tag information stored in a storage unit.

FIG. 9 is a diagram illustrating an example of a screen displayed on a display unit of the collection terminal device.

FIG. 10 is a sequence diagram illustrating an example of an article detection processing procedure performed by the collection support system.

FIG. 11 is a diagram illustrating an example of detection notification to a user.

FIG. 12 is a sequence diagram illustrating an example of a collection processing procedure.

FIG. 13 is a sequence diagram illustrating an example of the collection processing procedure.

FIG. 14 is a sequence diagram illustrating another example of the collection processing procedure.

FIG. 15 is an outline diagram of a collection support system of a second embodiment.

FIG. 16 is a flowchart illustrating an example of a processing procedure at the time of sale on a management server in the second embodiment.

FIG. 17 is a flowchart illustrating an example of a storage processing procedure for tag identification information of a collection support device in the second embodiment.

FIG. 18 is a sequence diagram illustrating an example of an article detection processing procedure performed by the collection support system of the second embodiment.

### DETAILED DESCRIPTION OF VARIOUS EMBODIMENTS

A collection support system uses a plurality of collection terminal devices installed at a plurality of locations to support collection of an article. Each of the plurality of collection terminal devices includes a reading unit that reads, from a tag in the form of a sticker or a sheet, identification information for identifying the tag. On the basis of the identification information read from the tag attached to an article, each of the plurality of collection terminal devices makes a notification of detection of the article to a seller, a manufacturer, a rental operator, or a carrier of the article or the tag corresponding to the identification information.

In the present specification, the meaning of the term “detection” includes “pick up”, “delivery”, and “arrival”.

On the basis of the identification information read from the tag, the collection terminal device makes a notification of the detection of the article to the seller, the manufacturer, the rental operator, or the carrier of the article with the tag or the tag itself. The seller, the rental operator, or the carrier notifies a user of the detection on the basis of customer data managed by each operator.

With the above configuration, the business operator who manages the tag identification information and the business operator who manages the customer data can cooperate to notify the user of the detection of the article.

(1) At the institution or facility where an article is delivered, by purchasing the collection terminal device or permitting the installation of the collection terminal device, the collection of the article can be promoted to reduce a resource conventionally required for the storage and management of the article.

(2) The business operator such as the seller or the rental operator of the article or the tag does not have to bear the burden of installing a collection terminal device that detects the tag at each location. By making the detection notification to the user, the business operator can expect the effect of increasing the points of contact with the user and improving the relationship.

(3) The business operator who manages the collection terminal device by transfer through sales or the like or by renting does not have to bear the burden of selling the article or the tag. The business operator who manages the collection terminal device notifies the detection with the business operator who sells the tag by using information that can specify the tag.

(1) to (3) above may be performed by different business operators or organizations (entities), or at least two of those may be performed by the same business operator or organization.

In the present specification, the meaning of the term “lost” includes “missing” and “stolen”.

The collection support system may further include a collection support device capable of coded communication connection with each of the plurality of collection terminal devices. Each of the plurality of collection terminal devices transmits a detection message of the article including the identification information read by the reading unit to the collection support device. The collection support device includes a reception unit that receives a notification of a detection message from the collection terminal device, and a transmission unit that transmits a detection notification of the article to the seller, the manufacturer, the rental operator, or the carrier associated with the tag identification information included in the detection message.

The tag identification information detected by the collection terminal devices installed at each location is transmitted as a detection message to each collection support device by secured coded communication. The association between the tag identification information and the business operator to be notified when the article with the tag is detected by the collection support device is stored. The collection support device can appropriately notify the business operator of the detection of the article with the tag by the information for specifying the tag agreed between the collection support system and the system of the business operator on the basis of the received detection message.

The detection notification transmitted from the collection support device to the business operator may be associated with location information indicating a detection place or a storage place associated with the information for identifying the collection terminal device.

With the above configuration, it is possible for the user who has received the notification of the detection of the article from the business operator to grasp where the article should be collected.

The collection terminal device may be mounted with an uninterruptible power system or may be connected to the uninterruptible power system.

With the above configuration, the article can be detected by the collection terminal device that is always in operation.

The tag may have an antenna and a storage medium built-in, and the reading unit of the collection terminal device may wirelessly read the tag identification information stored in the storage medium via the antenna.

The tag may be a tag having the form of a sticker or a sheet that does not require a communication device for wireless communication, a power supply for the device, or the like. Such a tag is cheaper than a tag provided with a communication means by Bluetooth and can thus be easily purchased by the user. The user can tag not only valuables such as a wallet and a bag but also an inexpensive item such as an umbrella, clothing, and accessories. Therefore, the collection of a huge quantity of umbrellas and clothing delivered to a lost item management center is promoted. Users are more likely to be able to collect umbrellas and clothing that would often be given up when being lost.

The collection terminal device is a device that constitutes the collection support system described above and includes a reading unit that reads, from a tag in the form of a sticker or a sheet, identification information for identifying the tag. On the basis of the identification information read by the reading unit from the tag attached to an article, the collection support device makes a notification of detection of the article to a seller, a manufacturer, a rental operator, or a carrier of the article or the tag corresponding to the identification information.

The collection support device includes a reception unit that receives a detection message including identification information of a sticker-like or sheet-like tag attached to an article. The collection support device includes a transmission unit that transmits, on the basis of the identification information of the tag included in the detection message, a detection notification of the article to a seller, a manufacturer, a rental operator, or a carrier of the article or the tag corresponding to the identification information.

In a collection support method, when at least one of the collection terminal devices installed at a plurality of locations has a tag in the form of a sticker or a sheet in a reading range, the identification information for identifying the tag is read from the tag. On the basis of the identification information, the collection support device that receives the detection message from the collection terminal device makes a notification of detection of the article to a seller, a manufacturer, a rental operator, or a carrier of the article or the tag corresponding to the identification information.

In the collection support method, a request for purchase or rental of the tag may be accepted by a management server of the seller or rental operator. The management server of the business operator stores the association between the user identification information of the client or the owner of the article with the tag and the information for specifying the tag. When the detection of the article including the information for specifying the tag is notified, the user may be notified from the seller, the manufacturer, the rental operator, or the carrier on the basis of the user identification information corresponding to the specification information of the tag.

In the collection support method, at the time of accepting a request for purchase or rental of the tag, the management server may accept an output request for outputting an image, a color, a character, or a pattern to the tag.

The present technique will be specifically described with reference to the drawings showing the embodiments thereof.

### First Embodiment

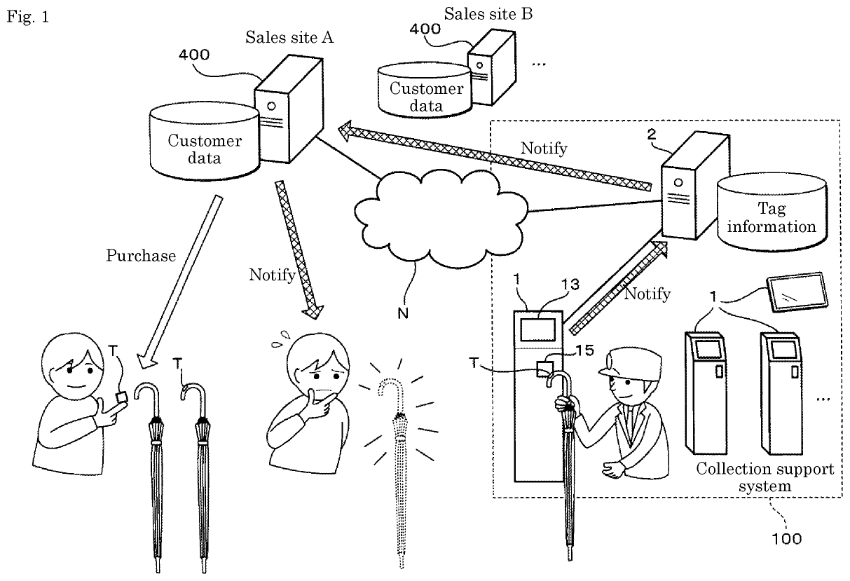

FIG. 1 is an outline diagram of a collection support system 100 of a first embodiment. The collection support system 100 includes a collection terminal device 1 installed at each location, a collection support device 2, and a network N. The collection support device 2 of the collection support system 100 can transmit and receive information by communicating with an electronic commerce service provider or a management server 400 managed by a carrier outside the system.

The user previously attaches (e.g., affixes) to an article a tag T in the form of a sticker or a sheet in which identification information is stored in a built-in storage medium. The identification information stored in the storage medium of the tag T is read by a reading unit of the collection terminal device 1 installed at each location, for example, a train station. For example, when the identification information is read by the collection terminal device 1 from the tag T of the lost article by the user, the collection terminal device 1 that has read the information transmits a detection message including the read identification information to the collection support device 2. The detection message is transmitted from the collection terminal device 1 to the collection support device 2 by coded communication via the network N including the public communication network.

The collection support device 2 that receives the detection message from the collection terminal device 1 makes a notification of the detection of the tag T to a seller of the tag T itself that is stored in association with the identification information of the tag T in advance or to a seller, the rental operator, or the carrier of an article with the tag T. Each business operator stores a destination for the user who is the purchaser or the user of the article as customer data. Upon receiving the notification of the detection of the tag T, each business operator transmits the detection to the user who purchased the tag T or the user who purchases or uses the article with the tag T. At this time, the detection notification to the user may include information on where and when the article can be collected. The notification to the user may be made through the user's e-mail address or the account in a message application or may be achieved by transmitting a postcard, a sealed letter, or the like to the address or by telephone contact.

In a case where the user who has been notified that the article with the tag T has been detected collects the article, a place for collection is required. The notification from the collection support device 2 to the business operator may include information on a place where the collection is possible. The business operator may present the place only when authentication registered for the user is successful so that the user can refer to the article collectable place. The notification includes options such as delivering, disposal, or selling the detected article to others, and the user is preferably able to select one of the options.

In this way, the collection support system 100 uses the tag T in the form of a sticker or a sheet T to support the user to collect the lost article. In the collection support by the collection support system 100, when the user purchases the article or the tag T, the user only needs to agree to associate account information of a mail-order service or a payment service used for the purchase with the tag identification information of the tag T and attach the tag T to the article. The found lost item may be delivered not only to the police station but also to a convenience store, a station, a financial institution, and the like, and in any case, the lost item is safely delivered to the user. Personal information on the user (user-specification information) is prevented from being seen by others.

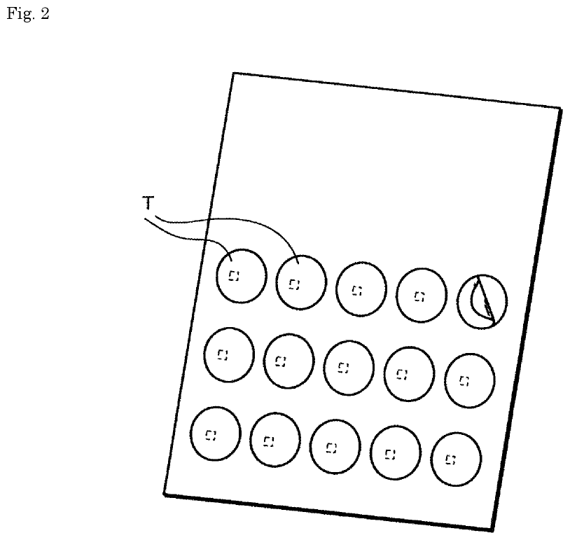

FIG. 2 is a schematic diagram illustrating one form of the tag T. The tag T in FIG. 2 is in the form of a sticker and can be used by being peeled from a sheet. Alternatively, the tag T may be a discriminator in the form of a sheet that stores identification information. The tag T is, for example, a non-contact integrated circuit (IC) tag seal based on the Felica (registered trademark) standard. The tag T is not limited to Felica but may include an IC chip based on the radio-frequency identifier (RFID). The tag T may be made of cloth and sewn with a non-contact IC tag. An image or a barcode may be printed on the surface of the tag T. As will be described later, the user is preferably able to select the desired design at the time of accepting the sale of the tag T. The identification information stored in the storage medium of the tag T may be common to a plurality of tags T or may be uniquely assigned to each tag T. The identification information stored in the IC chip may be coded so as not to be readable. The tag T can be replaced with a three-dimensional ornament that is not a sticker or a sheet. The tag T may be the cover of the article or a three-dimensional miscellaneous item attached to the article. The tag T may, for example, imitates a character or an animal attached to the handle of an umbrella and may include a non-contact IC tag inside

In the tag T in which 15 sheets are grouped together on one sheet as illustrated in FIG. 2, the same identification information is stored in the IC chip for all 15 sheets or a set of 5 sheets each. The manufacturing company of the tag T stores the identification information into the IC chip of the tag T on the basis of the request from the administrator of the collection support device 2. The tag T may also be used for a seal for identifying the source or an authenticity identification seal containing a trademark or the like relating to the article to be attached, or a tag or a label attached to the article, such as clothing.

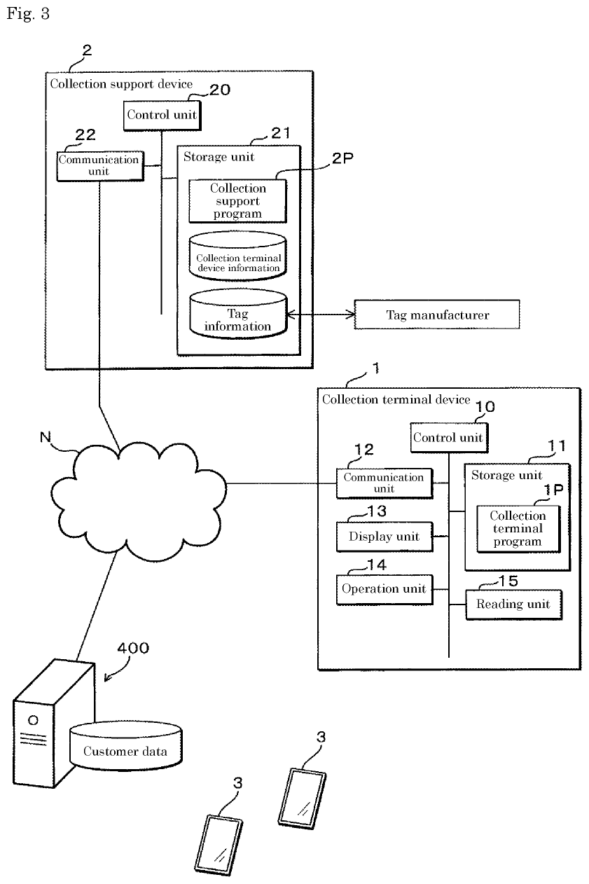

FIG. 3 is a block diagram of the collection support system 100. A Felica (registered trademark) compatible kiosk terminal installed at the station may be used as the collection terminal device 1, or the collection terminal device 1 may be installed at a lost item management center. A cash register terminal, an automated teller machine (ATM), or a receiving locker may be used as the collection terminal device 1. The collection terminal device 1 may exhibit a specific function by installing a specific collection terminal program 1P on a general-purpose tablet terminal.

The collection terminal device 1 includes at least a control unit 10, a storage unit 11, a communication unit 12, a display unit 13, an operation unit 14, and a reading unit 15. The collection terminal device 1 may have various component units corresponding to the types of devices used. The collection terminal device 1 may have a storage battery inside and be mounted with the function of an uninterruptible power system (UPS) or may be connected to the UPS.

The control unit 10 is a processor including a central processing unit (CPU) or a graphics processing unit (GPU) and uses a built-in memory such as read-only memory (ROM) and random-access memory (RAM) to control each component unit and execute the processing. The control unit 10 executes information processing based on the collection terminal program 1P stored in the storage unit 11.

The storage unit 11 uses, for example, a hard disk or a non-volatile memory such as a solid-state drive (SSD). The storage unit 11 stores various information referred to by the collection terminal program 1P and the control unit 10 described above. The storage unit 11 stores information generated by the processing of the control unit 10.

The communication unit 12 is a communication device corresponding to coded communication such as secure sockets layer (SSL) with the collection support device 2 via the network N. The communication unit 12 may be an interface for achieving a connection with the collection support device 2 via a dedicated line. The control unit 10 can be securely connected to the collection support device 2 via the communication unit 12.

The display unit 13 uses a display such as a liquid crystal display or an organic electroluminescence (EL) display. The display unit 13 displays an operation screen including characters and images by processing based on a terminal program including the collection terminal program 1P of the control unit 10. The display unit 13 may use a display with a built-in touch panel. The display unit 13 is not mandatory, and when the operation unit 14 is used as a vocal user interface, information may be output by voice instead of the display unit 13.

The operation unit 14 uses a touch panel built in the display of the display unit 13 or a button provided in the housing of the collection terminal device 1. The operation unit 14 is a voice input unit and may accept a voice operation by a voice recognition function. The operation unit 14 may be a keyboard and a pointing device capable of input/output to/from the control unit 10. With these configurations, the operation unit 14 notifies the control unit 10 of the operation information by the user or the operator.

The reading unit 15 is a reader that reads the tag identification information of the tag T. The reading unit 15 is a wireless tag reader. The reading unit 15 may be a barcode reader or a camera. The reading unit 15 may include both of those and selectively use either one depending on the mode of the tag T to read the tag identification information of the tag T. The reading unit 15 notifies the control unit 10 of the information read from the tag T.

The collection support device 2 includes a control unit 20, a storage unit 21, and a communication unit 22. Although the collection support device 2 is described as one server computer here, the functions or processing may be distributed among a plurality of server computers.

The control unit 20 is a processor using a CPU or a GPU and uses a built-in memory such as ROM and RAM to control each component unit and execute processing. The control unit 20 executes information processing based on a collection support program 2P stored in the storage unit 21.

The storage unit 21 uses a nonvolatile memory such as a hard disk or an SSD. The storage unit 21 stores various information referred to by the collection support program 2P and the control unit 20 described above. The storage unit 21 stores collection terminal device information including the association between the terminal identification information of the collection terminal device 1 and the information of the initial collectable place for the article detected by the collection terminal device 1. In association with the identification information of the tag T sold, the storage unit 21 stores tag information including identification information of a business operator selling or using the tag T and specification information of a business operator for specifying the user of the tag T in the business operator. The collectable place for the article with the tag T may be added to the tag information individually for each tag T in association with the identification information of the tag T. Specifically, the collection terminal device 1 of the detection place of the tag T or the lost item management center accepts the registration of the article collectable place by the operation of an administrator and transmits the information of the registered article collectable place to the collection support device 2, and the collection support device 2 stores the received information of the article collectable place in association with the tag identification information.

The specification information of the tag T described above means the information associated with the customer data in the management server 400 in order to specify the owner user of the tag T. The specification information is, for example, the identification information stored in the IC of the tag T. When the specification information is the same as the identification information stored in the IC of the tag T, it is not necessary to store the association. When the identification information stored in the IC of the tag T is used only in the collection support system 100, it is necessary for the storage unit 21 to store the specification information of the tag T independently granted by the business operator of the management server 400 in association with the identification information stored in the IC of the tag T. In this case, the specification information is, for example, a product number that is attached to the tag T and can specify the tag T between the seller and the purchaser.

The specification information may be a purchase number given when the purchaser purchases the tag T via the management server 400. The specification information may be a dedicated identification number or the like for specifying the tag T agreed between the management server 400 and the collection support system 100 in order to enable the management server 400 to specify the owner user of the article with the tag T.

The communication unit 22 is an interface that achieves communication via the network N. The control unit 20 achieves a communication connection with the collection terminal device 1 or the management server 400 of the business operator via the network N by the communication unit 22.

The processing performed by the collection support system 100 configured as above will be described below.

[Obtain Tag T]

The purchase of the tag T is accepted by the seller who sells the tag T itself or the seller of the article with the tag T. In the collection support system 100, the collection support device 2 receives information from the management server 400 when the tag T is sold in order to grasp which business operator should be notified when the sold tag T is detected by the collection terminal device 1.

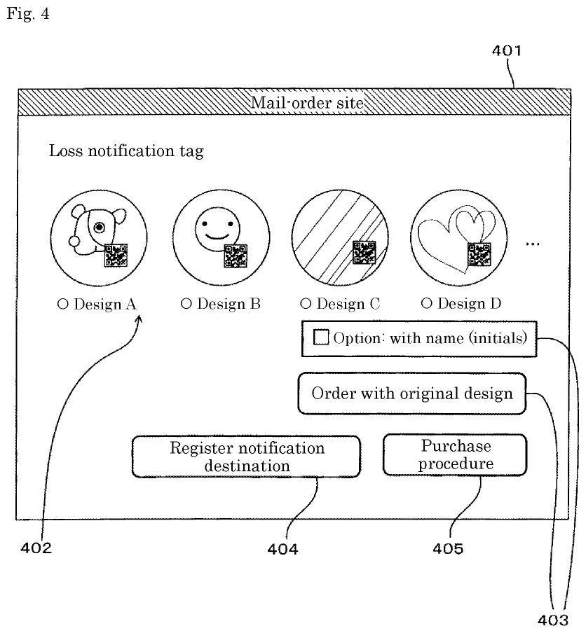

FIG. 4 illustrates an example of a screen displayed on a tag T sales site. FIG. 4 is displayed by, for example, the web server function of the management server 400 managed by the seller of the tag T. A sales screen 401 illustrated in the example of FIG. 4 includes a list 402 of purchasable tags T. The sales screen 401 includes a control 403 for design selection that optionally accepts an output request for an image, a color, a character, or a pattern to the tag T to be sold.

The sales screen 401 includes a registration control 404 for registering a notification destination in case of loss. When the registration control 404 is selected, the registration of the notification destination, such as the identification (ID) and the e-mail address of the user who is the purchaser, account information of a message application of an information terminal device 3 for the purchaser, or the address or the telephone number of the delivery destination user, is accepted. Customer data registered in advance on the sales site may be used. The registration of the notification destination of the user, who is not the purchaser but the owner of the article desiring to be notified by the tag T, may be accepted.

The tag T may be purchased at a store. In the case of the purchase at the store, the specification information of the tag T managed by the seller of the tag T or the article cannot be automatically associated with the customer data such as the address for notifying the user. In the case of the purchase at the store, the user who purchased the tag T or the store staff may register the specification information of the purchased tag T together with the notification destination of the user on the screen as illustrated in FIG. 4. In this case, the screen of FIG. 4 may be provided via a web server managed by the manufacturer or the carrier of the tag T or may be provided by a web server operated by a special business operator who performs only the service of notifying the detection.

The sales screen 401 includes a purchase procedure control 405 for the purchase procedure of the tag T selected in the list 402 and the tag T optionally selected in design.

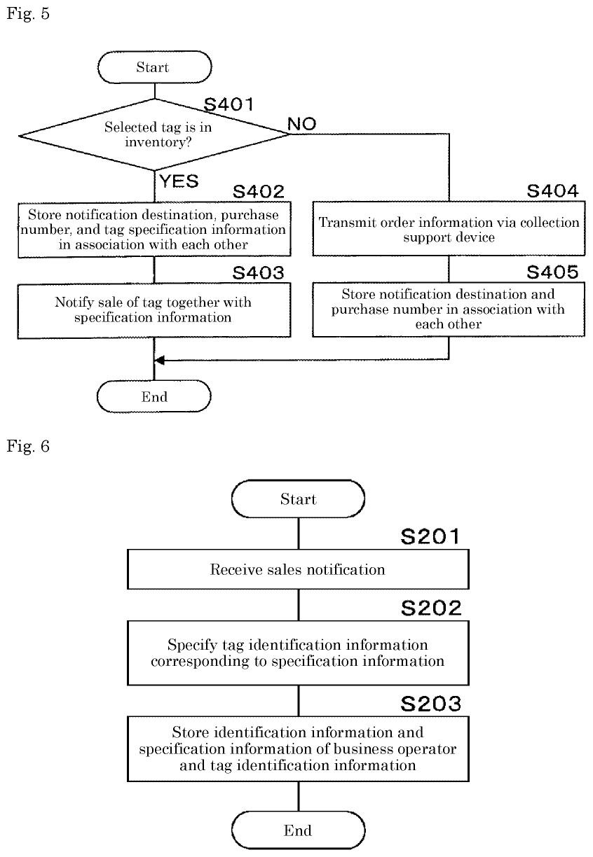

FIG. 5 is a flowchart illustrating an example of a purchase acceptance processing procedure based on the sales screen 401. The processing procedure illustrated in the flowchart of FIG. 5 is executed on the management server 400 when the purchase procedure control 405 is selected.

The management server 400 determines whether or not the selected tag T is under inventory management by the management server 400 (step S401). When the tag T is under inventory management (S401: YES), the management server 400 stores the association among the notification destination registered on the basis of the registration control 404, the purchase number specifying the purchase, and the specification information of the tag T to be shipped (step S402). Here, the specification information of the tag T may be a product number uniquely assigned by the seller to the sheet including the tag T, or the identification information itself stored in the IC chip of the tag T.

The management server 400 notifies the collection support device 2 of the sale of the tag T together with the specification information of the tag T (step S403) and terminates the processing. From this point onward, the collection support device 2 will monitor whether or not the tag T specified by the specification information of the tag T is detected.

When it is determined that the tag T is not under inventory management (S401: NO), the management server 400 orders the tag T from the manufacturer of the tag T. The management server 400 transmits the order information to the manufacturer of the tag T via the collection support device 2 (step S404). The order information includes a purchase number for specifying the purchase from the user. When the option of requesting the output of an image, a color, character or a pattern to the tag T is selected, the order information includes the information of the image, the color, the character or the pattern to be output.

The management server 400 stores the association between the notification destination registered on the basis of the registration control 404 and the purchase number (step S405) and terminates the processing. The storage processing of step S405 may be performed after the shipment of the tag T from the manufacturer is completed.

The processing on the management server 400 is not limited to the procedure illustrated in the flowchart of FIG. 5. On the basis of the customer data managed by the business operator, another method may be used when the customer data can be associated with the tag T possessed by the user so that the management server transmitted from the collection support system 100 for the detection notification of the tag T can notify the owner of the tag T and the owner of the article with the tag T.

FIG. 6 is a flowchart illustrating an example of a registration procedure for the identification information of the tag T in the collection support device 2. When receiving the sales notification from the management server 400 (step S201), the control unit 20 of the collection support device 2 specifies the identification information stored in the IC chip of the tag T corresponding to the specification information of the already sold tag T included in the sales notification (step 202). The control unit 20 stores into the tag information of the storage unit 21 the association among the business identification information for identifying the business operator who manages the management server 400, the specification information of the tag T in the business operator, and the identification information of the tag T (step S203) and terminates the processing.

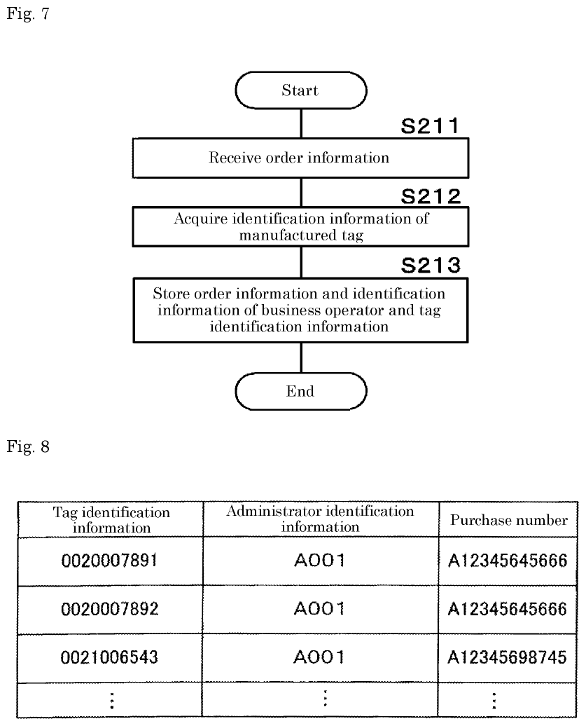

FIG. 7 is a flowchart illustrating an example of the registration procedure for the identification information of the tag T in the collection support device 2. The control unit 20 of the collection support device 2 receives the order information from the management server 400 (step S211). When the collection support device 2 receives the order information, information of an image, a color, character, or a pattern to be output to the tag T included in the order information and a manufacturing request are consigned to the manufacturer of the tag T. The control unit 20 acquires the identification information of the manufactured tag T (step S212). The control unit 20 stores, into the tag information, the association between the order information in step S211, the business operator identification information for identifying the business operator managing the management server 400 of the transmission source of the order information, and the identification information of the tag T acquired in step S212 (step S213) and terminates the processing.

In step S212, the identification information of the tag T may be designated at the time of consignment from the administrator of the collection support device 2 to the manufacturer of the tag T.

FIG. 8 is a diagram illustrating an example of the tag information stored in the storage unit 21. As illustrated in FIG. 8, in the tag information of the collection support device 2, the tag identification information “0020007891” stores the sales site identification information for identifying the administrator of the management server 400 who has sold or rented the tag T, and the purchase number. In the first embodiment, the purchase number is used so that the owner of the article with the tag T that stores the identification information “0020007891” can be specified by the management server 400. The identification information of the tag T is used only in the collection support system 100 and is thus desirably not notified to the management server 400. By separately managing the management server 400 that manages the customer data and the collection support system 100 that manages the identification information of the tag T, the burden of managing personal information is reduced. Since RFID can be read by a general-purpose device, it is expected that the tag T can be prevented from being misused by performing coding so that the tag T cannot be used outside the collection support system 100.

The tag information illustrated in FIG. 8 may be updated and stored for each tag identification information each time the state of the article with the tag T is attached changes. For example, the state of the article is initially a “pre-sale state”, and when the sale of the article is notified, the collection support device 2 changes the state to a “use state”. When the article is being used in a mode where a lost item report to be described later can be made, the state of the article is changed to a “lost state”. The state of the article is changed to a “detection state” when the tag T is detected by the collection terminal device 1.

[At Time of Loss]

When the user recognizes that the article with the tag T has been lost, the user may perform a registration procedure (loss report procedure) on a lost article registration screen provided by the management server 400. The lost article registration is not mandatory. In the registration procedure for the lost article, the user can register the lost article with respect to the user's customer data, that is, the user ID or the like for identifying the user.

When a well-intentioned third party finds the lost article, the third party delivers the article to the staff of any facility, such as a station employee at the station. The staff attempts to read the tag T of the article with the reading unit 15 of the collection terminal device 1 installed in the facility. When the article is tagged with the tag T, the collection terminal device 1 notifies the collection support device 2. The reading is performed as follows.

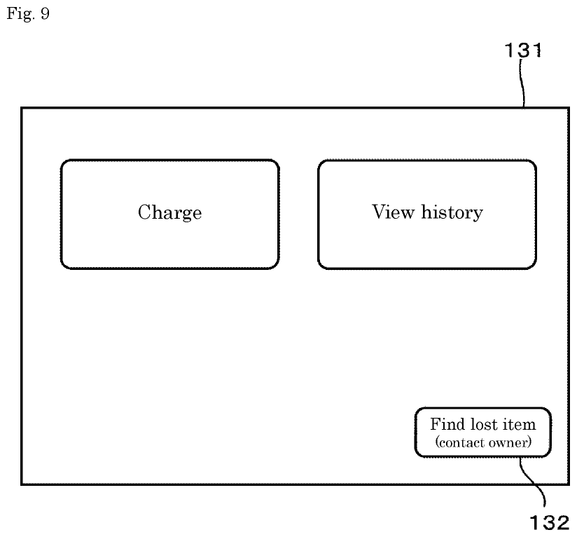

FIG. 9 is a diagram illustrating an example of a screen displayed on the display unit 13 of the collection terminal device 1. FIG. 9 illustrates an example in which the collection terminal device 1 is a station kiosk terminal. As illustrated in FIG. 9, a terminal screen 131 displayed on the display unit 13 of the collection terminal device 1 functioning as the kiosk terminal includes a lost item finding button 132 along with a button for charging a transportation IC card with an amount of money.

Like the lost item finding button 132 illustrated in FIG. 9, the display unit 13 or the operation unit 14 included in the collection terminal device 1 is provided with an interface for notifying the finding. When the staff performs an operation of selecting the interface for notifying the finding, a message prompting the reading unit 15 to perform a reading operation of the tag T is displayed on the display unit 13. The display unit 13 may display an interface for selecting the item of the found article. By performing the reading operation, the following processing is executed starting from the collection terminal device 1.

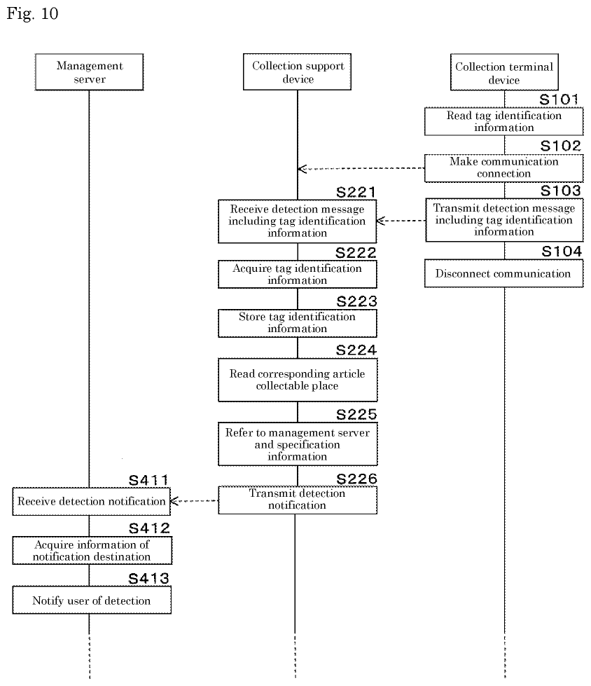

FIG. 10 is a sequence diagram illustrating an example of an article detection processing procedure performed by the collection support system 100.

The control unit 10 of the collection terminal device 1 reads the identification information of the tag T by the reading unit 15 (step S101). In step S101, the control unit 10 decodes the code of the information read by the reading unit 15. For coding and decoding, key information commonly used in the collection support system 100 may be used, or the key information set for each collection terminal device 1 may be used.

The control unit 10 requests a communication connection by coded communication such as SSL from the communication unit 12 to the collection support device 2 (step S102). When the collection support device 2 successfully authenticates the collection terminal device 1 and establishes a connection, the control unit 10 transmits a detection message including the identification information of the tag T read by the reading unit 15 to the collection support device 2 in association with the terminal identification information of the terminal itself stored in advance in the storage unit 11 (step S103). The terminal identification information does not have to be notified when it is known by the collection support device 2 through the communication connection between the collection terminal device 1 and the collection support device 2. When the notification is completed, the communication between the collection terminal device 1 and the collection support device 2 is disconnected (step S104).

In the collection terminal device 1, in a case where an item is selected when the tag T is read by the reading unit 15, the selected item may be registered in the storage unit 11 in association with the identification information of the tag T. In this case, the detection message transmitted from the collection terminal device 1 to the collection support device 2 in step S103 includes the item of the article (“umbrella”, “clothing”, “bag”, “telephone”, etc.).

The collection support device 2 receives a detection message from the collection terminal device 1 communicated and connected by the communication unit 22 (step S221), and the control unit 20 acquires the identification information of the tag T included in the detection message (step S222). The control unit 20 of the collection support device 2 instead of the collection terminal device 1 may decode the coded tag T identification information in step S222.

The control unit 20 stores the acquired identification information of the tag T into the storage unit 21 in association with the “detection state” (step S223). In step S223, the control unit 20 may update, to the “detection state”, the state information associated with the identification information acquired in step S222 among the identification information of the tag T included in the tag information.

The control unit 20 reads from the storage unit 21 an article collectable place stored in association with the terminal identification information of the collection terminal device 1 that is the notification source of the identification information of the tag T (step S224).

The control unit 20 refers to, from the tag information stored in the storage unit 21, the identification information of the management server 400 of the business operator and the specification information of the tag T (the purchase number in the first embodiment) associated with the identification information acquired in step S222 (step S225).

The control unit 20 transmits detection notification, including the location information of the article collectable place read in step S224 and the specification information (purchase number) of the tag T, to the management server 400 of the business operator referred to in step S225 (step S226). When the item of the article with the tag T is included in the detection message, the item of the article may also be included in the detection notification.

When receiving the detection notification (step S411), the management server 400 acquires information of the notification destination of the purchaser or the user of the tag T by referring to customer data on the basis of the specification information of the tag T included in the detection notification (step S412). The management server 400 transmits the detection notification to the user's information terminal device 3 on the basis of the information of the notification destination (step S413) and terminates the processing. As described above, the method for the detection notification may be any of a method using an e-mail address or a message application, delivery of a postcard, an envelope, or the like, or telephone contact.

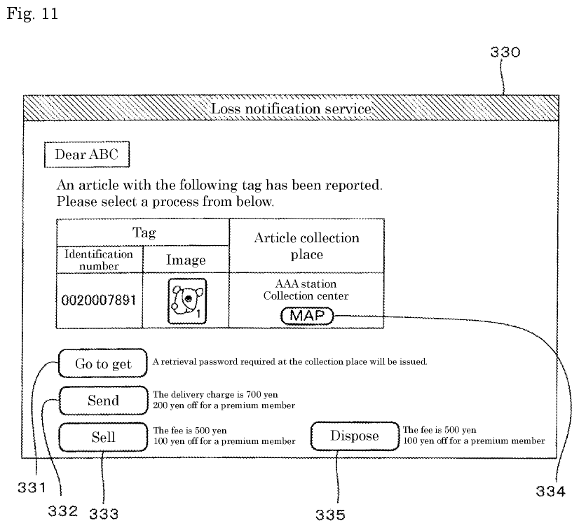

In response to the detection notification, the user can select what to do with the article with the detected tag T. FIG. 11 is a diagram illustrating an example of the detection notification to the user. FIG. 11 illustrates a notification screen 330 for the information terminal device 3 provided by the management server 400. The notification screen 330 contains an image of the tag T and information for specifying the article collectable place. The article collectable place may also include a button 334 for displaying a map illustrating the place. The notification screen 330 includes an interface for selecting the user's action on the detected article. The interface includes an icon 331 for starting a procedure for the case of the user going to get the article, an icon 332 for shipping the article to the home similarly to the shipping by a mail-order service, and an icon 333 for giving up the collection and performing a procedure for selling in the mail-order service. As illustrated in FIG. 11, the notification screen 330 may include an icon 335 for performing a disposal procedure. When an address is selected as a notification destination, a personal identification number for going to get the article is issued and notified by a postcard in which the personal identification number is described. In the case of a postcard, a telephone operation method may be described for the procedures corresponding to the icon 332 for sending and the icon 333 for selling. When the found article is a smartphone, and the selected notification destination is a notification to an e-mail address or a message application account, the management server 400 preferably recognizes this and takes measures such as making a notification by a postcard.

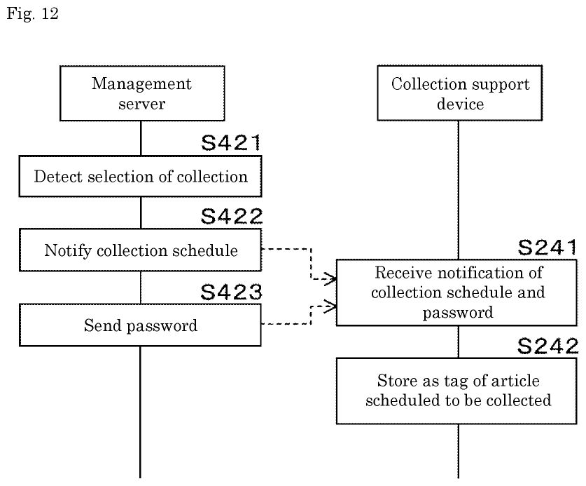

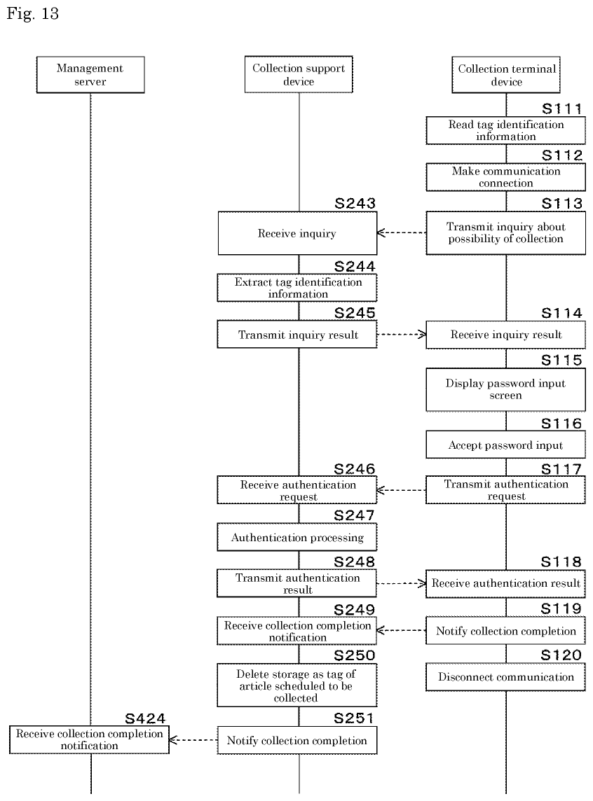

When the action is selected by the user, the collection is started by the management server 400 that detects the action. First, a case in which going to get (collect) the article is selected will be described. FIGS. 12 and 13 are sequence diagrams illustrating an example of the collection processing procedure.

As illustrated in FIG. 12, when the management server 400 detects that the collection has been selected by the user (step S421), the management server 400 notifies the collection support device 2 that the collection is scheduled together with the specification information for specifying the target tag T (step S422). The management server 400 issues a password for retrieval, notifies the user of the password and securely transmits the password to the collection support device 2 by coding the password in association with the notification of the collection schedule (step S423).

In the collection support device 2, the communication unit 22 receives the notification of the collection schedule and the password from the management server 400 (step S241). The control unit 20 stores the identification information of the tag T corresponding to the specification information of the tag T included in the notification into the tag information of the storage unit 21 in association with that the article is in a collection scheduled state (step S242).

The collection processing proceeds when the user who is the owner of the lost article visits a place where the lost item can be collected. For example, when the user calls out to the staff of the facility, the staff guides the article to be specified, and the collection terminal device 1 installed in the storage place accepts the processing. The position of the detected article in the storage place may be stored in association with the tag information of the collection support device 2 so that the collection terminal device 1 can refer to the position.

As illustrated in FIG. 13, the control unit 10 of the collection terminal device 1 reads the identification information of the tag T of the article to be collected by the reading unit 15 (step S111). The control unit 10 requests a communication connection by SSL coded communication from the communication unit 12 to the collection support device 2 (step S112).

When the collection support device 2 successfully authenticates the collection terminal device 1, and the connection is established, the control unit 10 associates the terminal identification information of the terminal itself stored in advance in the storage unit 11 with identification information of the tag T read by the reading unit 15 and transmits an inquiry as to whether or not the collection is possible to the collection support device 2 (step S113).

When the collection support device 2 receives the inquiry (step S243), the control unit 20 extracts the identification information of the tag T included in the inquiry from the tag information stored in the storage unit 21 (step S244). The control unit 20 confirms that the article is in the collection scheduled state and transmits the inquiry result to the collection terminal device 1 (step S245). When the article is not in the collection scheduled state, in step S245, the control unit 20 transmits as an inquiry result that collection is not possible.

In the collection terminal device 1, when the collection support device 2 confirms that the article is in the collection scheduled state and receives an inquiry result indicating that the collection is possible (step S114), the control unit 10 causes the display unit 13 to display an input screen of a password for retrieval (step S115). The control unit 10 accepts the password input by the operation unit 14 (step S116). In step S115, when the user has brought the information terminal device 3, the display unit of the information terminal device 3 is caused to display an image of the password such as a barcode, and the reading unit 15 reads and accepts the image as the password. On the basis of the password accepted in step S116, the control unit 10 transmits an authentication request as to whether or not the owner is a legitimate owner to the collection support device 2 (step S117).

When receiving the authentication request (step S246), the collection support device 2 executes the authentication processing on the basis of the password received in step S241 (step S247). The collection support device 2 transmits the result of the authentication processing to the collection terminal device 1 (step S248).

The collection terminal device 1 receives the result of the authentication processing (step S118), and when the processing has been successful, the staff hands the article. When the article is in a locked locker, the locker may be unlocked. When the handing and receiving are completed, the collection terminal device 1 notifies the collection support device 2 of the collection completion (step S119), and the communication is disconnected (step S120).

When receiving the notification of the collection completion (step S249), the collection support device 2 deletes the “collection scheduled state” associated with the corresponding tag identification information of the tag T (step S250) and further notifies the management server 400 of the collection completion (step S251).

The management server 400 receives the notification of the collection completion (step S424) and terminates the processing.

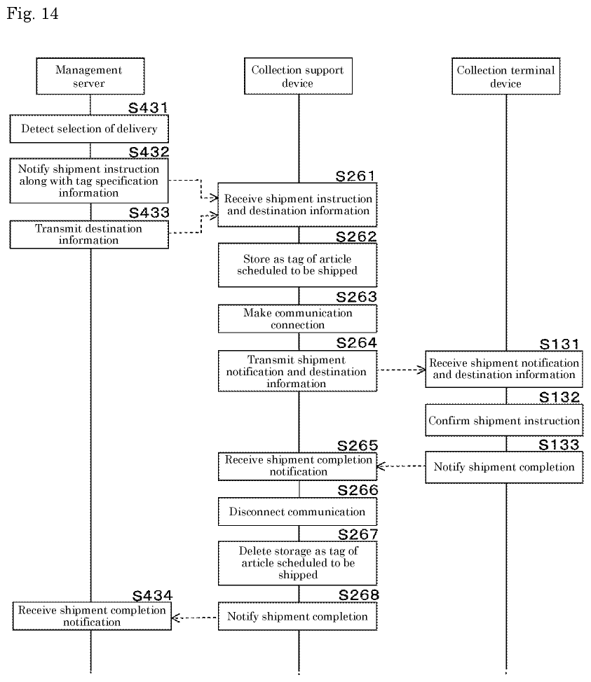

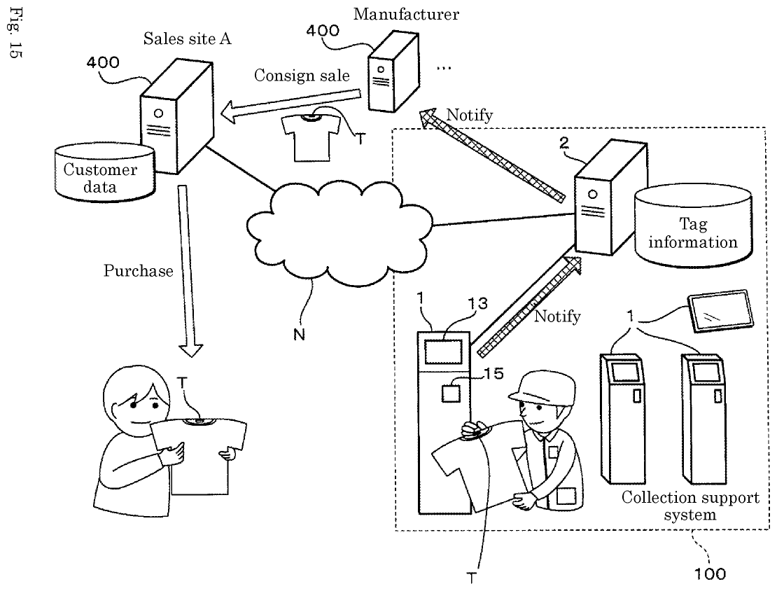

A case in which sending (deliver) the article is selected will be described. FIG. 14 is a sequence diagram illustrating another example of the collection processing procedure.

When the management server 400 detects that the delivery has been selected (step S431), the management server 400 transmits a shipment instruction to the collection support device 2 together with specification information for specifying the target tag T (step S432). The management server 400 transmits the destination information of the delivery destination to the collection support device 2 (step S433). The destination information is an address specified by the user, the address of the distribution center of the business operator, or the like.

When the collection support device 2 receives the shipment instruction and the destination information (step S261), the control unit 20 stores the fact that the article is scheduled to be shipped into the storage unit 21 in association with the identification information of the tag T corresponding to the specification information of the tag T included in the shipment instruction (step S262). The control unit 20 makes a communication connection with the collection terminal device 1 managed at a place for collection associated with the tag identification information of the tag T to be shipped (step S263), and transmits the shipment notification together with the destination information in association with the tag identification information of the tag T of the article to be delivered (step S264). Instead of steps S263 and S264, the control unit 20 of the collection support device 2 may notify the administrator of the collection terminal device 1 at the place for collection of the shipment instruction including the shipping details by e-mail or the like.

In the collection terminal device 1, when the shipment notification and the destination information are received together with the tag identification information of the target tag T (step S131), the control unit 10 causes the display unit 13 to display information on the tag T to be shipped and causes the staff of the facility or a conveyance device of the material handling system to confirm that the shipment processing is necessary (step S132). When the staff who has recognized the shipment or the transport device of the material handling system performs the shipment procedure on the basis of the received destination information, the operation unit 14 inputs the shipment completion. When the control unit 10 accepts the operation of the shipment completion input, the control unit 10 notifies the collection support device 2 of the shipment completion (step S133). The shipping may not be performed by the business operator who manages the collection terminal device 1 but may be achieved by the business operator of the management server 400 going to the facility where the article is detected and collecting the article together with other deliverables.

In the collection support device 2, When the shipment completion notification is received (step S265), the communication connection is cut off (step S266), and the control unit 20 deletes the shipment schedule information associated with the tag identification information of the tag T that has been updated and stored in the storage unit 21 (step S267). The control unit 20 notifies the management server 400 of the shipment completion (step S268).

In the management server 400, when the notification of the shipment completion is received (step S434), the processing is terminated.

When selling the article is selected, the collection is performed in a procedure similar to that illustrated in FIG. 14. However, the collection destination of the article is the distribution center of the business operator of the management server 400 or the like. The business operator of the management server 400 may go to the facility where the article has been detected and collect the article together with other deliveries. Also, when disposing of the article is selected, the article may be delivered to the warehouse of the business operator of the management server 400 or a specific designated address, or the article may be disposed of together with other wastes at the facility where the article has been.

In this way, the collection support system 100 manages the identification information of the tag T from the time of manufacture and sale of the tag T, and when the identification information is read by the collection terminal device 1, the identification information is securely authenticated and then notified to the business operator, such as the seller or the rental operator, of the tag T By using the tag T, which has a low unit price in the form of a sticker or a sheet, the burden on the user is reduced to support the collection of lost items. It is possible to improve the convenience of the lost item notification service and promote the spread of the service.

In the first embodiment, on the premise that the article is delivered to a facility such as a station of public transportation by a well-intentioned third party when the article is lost, the staff of the collected facility notifies that the article has been found from the collection terminal device 1. It is not limited to the case where the lost article is found in good faith, and when the lost article is intended to be used illegally, the user may be notified through the collection support device 2 that the lost article has been found by detecting the use in the collection terminal device 1 and making a notification of the use. Specifically, when the tag T is attached to an article to be used, the collection terminal device 1 reads the tag identification information and collates the read information with the tag identification information of the tag T for which a loss report has been submitted. When the tag T attached to the article is the tag T for which the loss report has been submitted, the use of the article is stopped, and a notification is made. This is useful because it is possible to detect illegal use when the target article is a credit card, prepaid card, or the like. When the lost article is found or used illegally, the notification destination may be not only the user but also the card company or the business operator of the collection support device 2.

### Modification Example

The transaction of the tag T is not limited to the mode in which the tag is attached to the article purchased by the mail-order service provided by the management server 400 as in the first embodiment described above or the mode in which the tag itself is purchased. For example, when a purchaser purchases an article, the tag T may be issued at the cash register terminal. In this case, the user-specific information associated with the tag identification information of the tag T may be not the account information of the mail-order service but user information used in a payment service called electronic money.

When a user purchases portable miscellaneous goods such as an umbrella at a convenience store retail store, the issuance of the tag T may be selected at the time of payment so that the tag T can be used on the spot In this case, a cash register terminal that can also function as the collection terminal device 1 is used, and a confirmation screen as to whether or not to use the loss notification service is displayed. When the user selects to use the service, the cash register terminal makes a payment with electronic money as described above. The cash register terminal functions as the collection terminal device 1 and reads the tag identification information of the tag T provided as an accessory. The tag T may be a mode issued as a part of the receipt. Information for specifying payment information is transmitted from the collection terminal device 1 to the management server 400 that provides the payment service, and processing for storing the information for specifying the tag T in association with the account information of the user specified by the payment information in the management server 400 is executed. The retail store staff hands the tag T along with a product (umbrella) to a user who is a purchaser. The user attaches the tag T to the purchased product and uses the product. Subsequent processing is the same as that of the first embodiment described above.

Similarly, when a user purchases a souvenir at a station premise or a store in the vicinity, the user may select the issuance of the tag T in the form of a seal at the time of payment with electronic money and attach the tag T to the package of the souvenir on the spot. Even when the user leaves the souvenir in the train, the staff of the railway company reads the tag T by using the collection terminal device 1, so that the user can grasp at which station the souvenir has been found and carry out the delivery procedure in response to the request.

### Second Embodiment

The collection support system 100 of the first embodiment has been a system that notifies the user who is the owner of the lost item that the lost item has been detected and supports the collection. In a second embodiment, the tag T may already be affixed or embedded in the article at the time of sale of the article. An article to be collected is an article that can be recycled. The article may be clothing, various plastic products, various electric products, batteries, and the like. The collection support system 100 notifies the manufacturer or the user of the article that the article purchased by the user has been collected for recycling and supports the collection.

FIG. 15 is an outline diagram of the collection support system 100 of the second embodiment. The collection support system 100 includes the collection terminal device 1 installed in a processing facility that recycles a collected article, the collection support device 2, and the network N. The collection support device 2 of the collection support system 100 can transmit and receive information by communicating with the manufacturer, the collection operator, and the electronic commerce service provider of the article or the management server 400 managed by a carrier outside the system.

The tag T may be attached to the article to be recycled in advance by the manufacturer. The tag T may be sewn onto the article. The tag T may be a non-contact IC tag and embedded in the article.

The management server 400 may store specification information for specifying the tag T. In the management server 400 managed by the electronic commerce service provider, it is preferable to store the specification information of the tag T in association with customer data.

When the article to be recycled is collected at the processing facility via the collection operator, the reading unit of the collection terminal device 1 reads the identification information stored in the storage medium of the tag T. The collection terminal device 1 that has read the identification information transmits a detection message including the read identification information to the collection support device 2. The detection message may be transmitted from the collection terminal device 1 to the collection support device 2 by coded communication via the network N including the public communication network.

The collection support device 2 that has received the detection message from the collection terminal device 1 notifies a manufacturer, a seller or a carrier of an article with the tag T stored in advance in association with the identification information of the tag T that the article has been collected in a recycling processing facility, and the tag T has been detected. Thereby, for example, the manufacturer can recognize that the article with the tag T has been collected.

The management server 400 of the seller stores customer data identifying the purchaser of the article tagged with the tag T. In the management server 400 managed by the seller, the specification information of the tag T provided from the manufacturer of the article and the identification information of the purchaser are stored in association with each other, and points can be granted to the purchaser as a reward for collection on the basis of the specification information of the tag T of the article collected in the recycling processing facility. By granting points, the effect of promoting collection is expected.

Since the hardware configuration of the collection support system 100 in the second embodiment is the same as that in the first embodiment, the same reference numerals are used and a detailed description of each unit is omitted. The second embodiment differs from the first embodiment in that it is not mandatory to notify the purchaser of the article of the detection. Hereinafter, the processing content of the collection support system 100 in the second embodiment will be described.

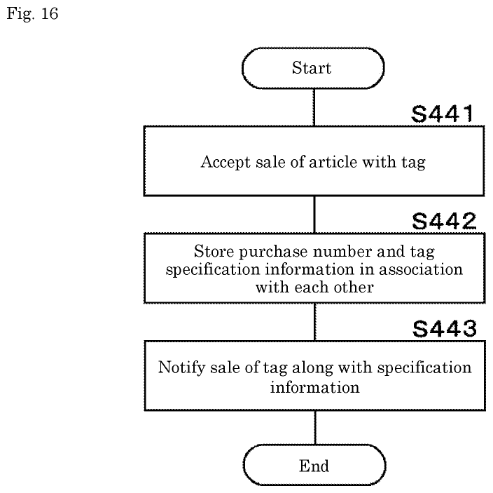

FIG. 16 is a flowchart illustrating an example of a processing procedure at the time of sale in the management server 400 in the second embodiment. The processing procedure illustrated in FIG. 16 may be performed by the manufacturer at the time of shipment.

When the management server 400 accepts the sale of the article with the tag T (step S441), the management server 400 stores the purchase number for specifying the purchase of the article and the specification information of the tag T (identification information stored in the tag T) in association with each other (step S442). The specification information of the tag may be a code uniquely assigned by the seller. The management server 400 notifies the collection support device 2 of the sale of the tag T together with the specification information of the tag T (step S443) and terminates the processing.

When the flowchart of FIG. 16 is executed at the time of shipment from the manufacturer, or when points are not granted to the user as a reward for collecting the article, the management server 400 may store the number of shipments or sales of the articles in place of step S442. In step S443, the number of shipments or the number of sales may be notified.

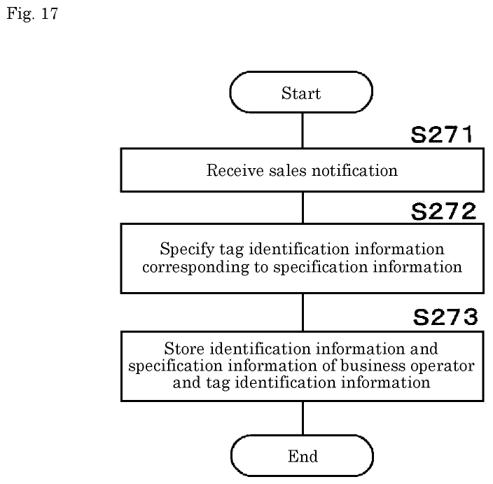

FIG. 17 is a flowchart illustrating an example of a storage processing procedure for the identification information of the tag T of the collection support device 2 in the second embodiment. When receiving the sales notification from the management server 400 (step S271), the control unit 20 of the collection support device 2 specifies the identification information stored in the IC chip of the tag T corresponding to the specification information of the already sold tag T included in the sales notification (step 272). The control unit 20 stores into the tag information of the storage unit 21 the association among the business identification information for identifying the business operator who manages the management server 400, the specification information of the tag T in the business operator, and the identification information of the tag T (step S273) and terminates the processing.

The flowchart of FIG. 17 is not mandatory. The storage unit 21 of the collection support device 2 in the second embodiment may store the identification information of the tag T provided to the manufacturer at least in association with business operator identification information for identifying the manufacturer.

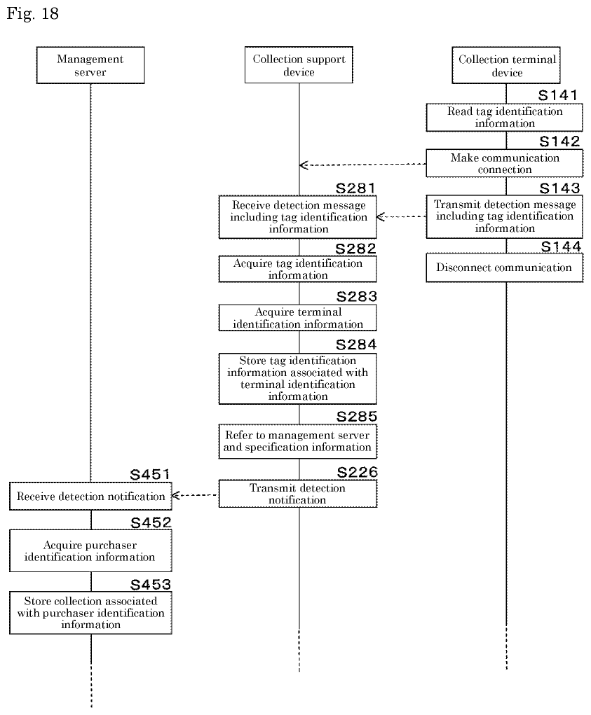

FIG. 18 is a sequence diagram illustrating an example of an article detection processing procedure performed by the collection support system 100 of the second embodiment. By the collection terminal device 1 performing a reading operation, the following processing is executed starting from the collection terminal device 1.

The control unit 10 of the collection terminal device 1 reads the identification information of the tag T by the reading unit 15 (step S141). In step S141, the control unit 10 decodes the code of the information read by the reading unit 15. For coding and decoding, key information commonly used in the collection support system 100 may be used, or the key information set for each collection terminal device 1 may be used.

The control unit 10 requests a communication connection by coded communication such as SSL from the communication unit 12 to the collection support device 2 (step S142). When the collection support device 2 successfully authenticates the collection terminal device 1 and establishes a connection, the control unit 10 transmits a detection message including the identification information of the tag T read by the reading unit 15 to the collection support device 2 in association with the terminal identification information of the terminal itself stored in advance in the storage unit 11 (step S143). The terminal identification information does not have to be notified when it is known by the collection support device 2 through the communication connection between the collection terminal device 1 and the collection support device 2. When the notification is completed, the communication between the collection terminal device 1 and the collection support device 2 is disconnected (step S144).

The collection support device 2 receives a detection message from the collection terminal device 1 communicated and connected by the communication unit 22 (step S281), and the control unit 20 acquires the identification information of the tag T included in the detection message (step S282). The control unit 20 of the collection support device 2 instead of the collection terminal device 1 may decode the coded tag T identification information in step S282.

The control unit 20 acquires the terminal identification information of the collection terminal device 1 that is the notification source of the identification information of the tag T (step S283). The control unit 20 stores the identification information of the tag T as a collection history in association with the terminal identification information (step S284).

The control unit 20 refers to, from the tag information stored in the storage unit 21, the identification information of the management server 400 of the business operator and the specification information of the tag T (the purchase number in the present embodiment) associated with the identification information acquired in step S282 (step S285).

The control unit 20 transmits the detection notification including the specification information of the tag T, for example, the purchase number, to the management server 400 of the business operator referred to in step S285 (step S286).

When receiving the detection notification (step S451), the management server 400 acquires the identification information of the purchaser of the tag T by referring to customer data on the basis of the specification information of the tag T included in the detection notification (step S452). The management server 400 stores the collection in association with the identification information of the purchaser (step S453) and terminates the processing.

When the seller does not grant points to the purchaser as a reward for collection, or when the management server 400 is managed by the manufacturer, the management server 400 records the collection in association with the specification information of the tag T in place of step S453. The management server 400 may only count the number of times the article has been collected.

In the second embodiment, the manufacturer or the seller of the article is notified that the article purchased by the user has been collected for recycling. Even when a recyclable article is not collected by the manufacturer of the article, the manufacturer can recognize that the collection is performed in the recycling processing facility together with other recyclable articles. The manufacturer can make efforts to increase the collection rate of articles shipped and contribute to a reduction in illegally dumped waste and a reduction in plastic waste. The seller can return points to the customer in accordance with the number of recyclable articles collected and the collection rate that can be specified for each customer. It is possible to visualize the contribution of the user and the seller of the articles and to improve the motivation for the recycling processing.

The disclosed embodiments are exemplary and not restrictive. The scope of the present invention is indicated by the claims and includes all modifications within the meaning and scope of the claims.

1. A collection support system that uses a plurality of collection terminal devices installed at a plurality of locations to support collection of an article, wherein:
each of the plurality of collection terminal devices includes a reading unit that reads, from a tag in a form of a sticker or a sheet, identification information for identifying the tag, and
on a basis of the identification information read from the tag attached to an article, each of the plurality of collection terminal devices makes a notification of detection of the article to a seller, a manufacturer, a rental operator, or a carrier of the article or the tag corresponding to the identification information.

2. The collection support system according to claim 1, further comprising a collection support device capable of coded communication connection with each of the plurality of collection terminal devices, wherein:
each of the plurality of collection terminal devices includes a communication unit that transmits a detection message of the article including the identification information read by the reading unit to the collection support device, and
the collection support device includes:
a reception unit that receives a detection message from the collection terminal device, and
a transmission unit that transmits a detection notification of the article to the seller, the manufacturer, the rental operator, or the carrier associated with the identification information of the tag included in the detection message.

3. The collection support system according to claim 2, wherein the collection support device stores the association between the identification information of the tag and a business operator to be notified when the article with the tag is detected.

4. The collection support system according to claim 2, wherein the transmission unit of the collection support device transmits the detection notification in association with location information indicating a detection place or a storage place associated with the information for identifying the collection terminal device.

5. The collection support system according to claim 1, wherein the collection terminal device is mounted with an uninterruptible power system or is connected to the uninterruptible power system.

6. The collection support system according to claim 1, wherein:
the tag has an antenna and a storage medium built-in, and
the reading unit wirelessly reads the identification information of the tag stored in the storage medium via the antenna.

7. A collection terminal device comprising:
a reading unit that reads, from a tag in a form of a sticker or a sheet, identification information for identifying the tag,
wherein on a basis of the identification information read by the reading unit from the tag attached to an article, the collection terminal device makes a notification of detection of the article to a seller, a manufacturer, a rental operator, or a carrier of the article or the tag corresponding to the identification information.

8. A collection support device comprising:
a reception unit that receives a detection message including identification information of a sticker-like or sheet-like tag attached to an article; and
a transmission unit that transmits, on a basis of the identification information of the tag included in the detection message, a detection notification of the article to a seller, a manufacturer, a rental operator, or a carrier of the article or the tag corresponding to the identification information.

9. The collection support device according to claim 8, further comprising:
a storage unit that stores tag information,
wherein the storage unit stores association among business operator identification information for identifying a business operator to which the detection notification is to be transmitted, specification information of the tag in the business operator, and the identification information of the tag.

10. A collection support method for supporting collection of an article, comprising:
reading, by at least one of collection terminal devices installed at a plurality of locations, identification information for identifying a tag in a form of a sticker or a sheet from the tag when the tag is in a reading range; and
making, by the collection support device that receives a detection message from the collection terminal device, a notification of detection of the article to a seller, a manufacturer, a rental operator, or a carrier of the article or the tag corresponding to the identification information on a basis of the identification information.

11. The collection support method according to claim 10, wherein:
a management server of the seller or the rental operator accepts a purchase or rental request for the tag,
association between user identification information of a client or an owner of an article with the tag and information for specifying the tag is stored, and
when detection of the article including the information for specifying the tag is notified, the detection is notified to a user from the seller, the manufacturer, the rental operator, or the carrier on a basis of the user identification information corresponding to the specification information of the tag.

12. The collection support method according to claim 10, wherein the management server accepts an output request for an image, a color, a character, or a pattern to the tag when accepting the purchase or rental request for the tag.

13. The collection support method according to claim 11, wherein the management server accepts an output request for an image, a color, a character, or a pattern to the tag when accepting the purchase or rental request for the tag.

14. The collection support system according to claim 3, wherein the transmission unit of the collection support device transmits the detection notification in association with location information indicating a detection place or a storage place associated with the information for identifying the collection terminal device.
